(19) United States
(12) Patent Application Publication
(10) Pub. No.: US 2006/0248932 A1
(43) Pub. Date: Nov. 9, 2006

(54) Compound locking device

(76) Inventor: Ping-Jan Yang, Taipei (TW)

Correspondence Address: PING-JAN YANG, P.O. BOX 26-757, TAIPEI, 106, TW

(21) Appl. No.: 11/123,694

(22) Filed: May 9, 2005

(51) Int. Cl. E05B 37/00; E05B 37/02

(52) U.S. Cl. 70/284; 70/285

(57) ABSTRACT

A compound locking device has a casing, and a combination locking mechanism and a key locking mechanism disposed in different positions in the casing. The combination locking mechanism has a plurality of pairs of figure wheels and positioning cam sleeves. Each positioning cam sleeve has a limiting portion. All the limiting portions will form a large limiting groove if all figures are correct. The key locking mechanism has a lock body, a first bushing, a second bushing, and a tongue plate. The first bushing is linked with the lock body to be rotatable. The first and second bushings are connected together by means of wedge grafting. The first bushing is rotated to leave the second bushing for embedding the tongue plate into the large limiting groove. The lock body can thus drive the first bushing to rotate for unlocking the compound locking device.

### BACKGROUND OF THE INVENTION

1. Field of the Invention

The present invention relates to a compound locking device and, more particularly, to a lock assembly consisting of a key locking mechanism combined with a combination locking mechanism.

2. Description of Related Art

A compound locking device makes use of two kinds of different locks jointly arrested by the same lock body so that the lock body can be opened only if both the locks are unlocked. In other words, if only one lock is unlocked, the lock body cannot be opened, thereby achieving the object of double arrestment.

FIG. 1 shows a compound locking device 1. The compound locking device 1 comprises a key locking mechanism 11, a positioning plate 12, a combination locking mechanism 13, and a reset member 14. An outer cylinder 112 of the key locking mechanism 11 is sleeved onto a lock head 111 of the key locking mechanism 11. The positioning plate 12 can restrain the outer cylinder 112 from rotating. The combination locking mechanism 13 controls whether the positioning plate 12 restrains the outer cylinder 112 from rotating based on whether the input set of numbers is the same as a preset code. If the input set of numbers is correct, the outer cylinder 112 can rotate. The reset member 14 protrudes from the other side of a key hole of the key locking mechanism 1.1. The reset member 14 can lead the combination locking mechanism 13 to a state in which the preset code can be changed.

The prior art compound locking device makes use of the key locking mechanism 11 and the combination locking mechanism 13 for joint arrestment. Figure wheels 131 of the combination locking mechanism 13 are serially connected together, and edges of the figure wheels 131 dialed by the user are located on the same side of the lock body thereof (i.e., the front face of the compound locking device 1). Others can easily dial the figure wheels 131 on the same side to try out the unlocking number. Moreover, when the prior art combination locking mechanism 13 is assembled, because of the existence of a flexible device 134, it is necessary to sleeve, in turn, the figure wheels 131 and the positioning cam sleeves 132 onto a shaft 133, one by one, under the influence of elastic force. Besides, it is also necessary to position the positioning cam sleeves 132, and the figure wheels 131, one by one. Therefore, the assembly of the prior art combination locking mechanism 13 is very cumbersome.

### SUMMARY OF THE INVENTION

One object of the present invention is to provide a compound locking device to allow a combination locking mechanism thereof to be able to prevent effectively others from trying out the unlocking number, and to facilitate the assembly of the combination locking mechanism.

To achieve the above object, the present invention provides a compound locking device comprising a casing, a combination locking mechanism, and a key locking mechanism. The combination locking mechanism is disposed at a position in the casing. The combination locking mechanism has a plurality of pairs of figure wheels and positioning cam sleeves pivotally connected to the casing and arranged in at least two rows. Each positioning cam sleeve has a limiting portion. All limiting portions form a whole large limiting groove if all the figures are correct. The key locking mechanism is pivotally disposed at another position in the casing. The key locking mechanism has a lock body, a first bushing, and a second bushing, respectively sleeved onto the lock body, and a tongue plate is disposed on the second bushing. The first bushing is linked with the lock body to be rotatable. The first and second bushings are connected together by means of wedge grafting. The first bushing can be rotated to leave the second bushing for driving the tongue plate to be embedded into the large limiting groove.

### BRIEF DESCRIPTION OF THE DRAWINGS

The various objects and advantages of the present invention will be more readily understood from the following detailed description when read in conjunction with the appended drawing, in which:

FIG. 1 is an exploded perspective view of a prior art compound locking device;

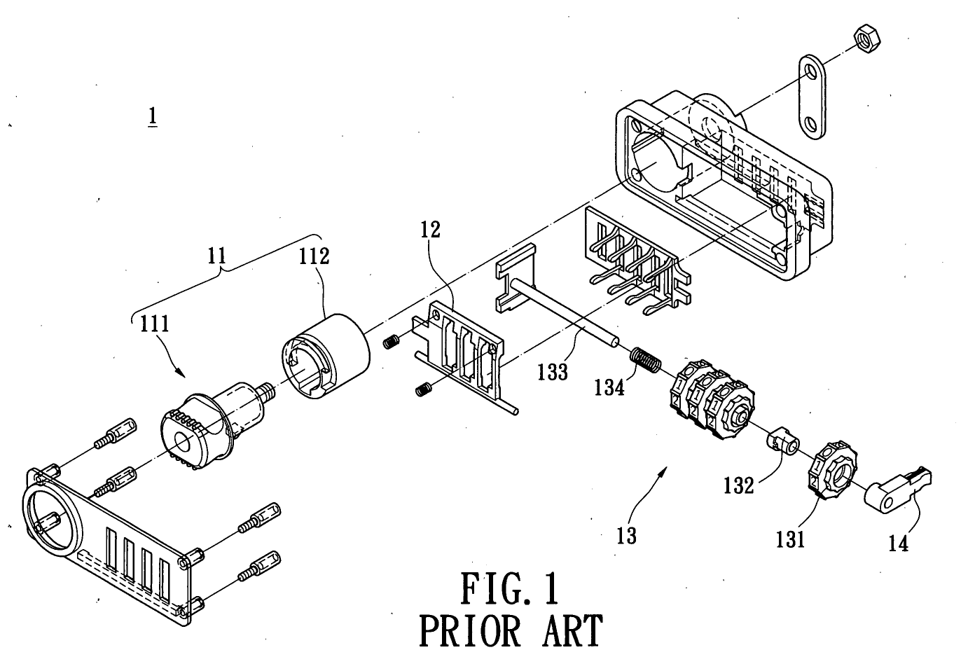

FIG. 2 is a perspective view of the prior art compound locking device;

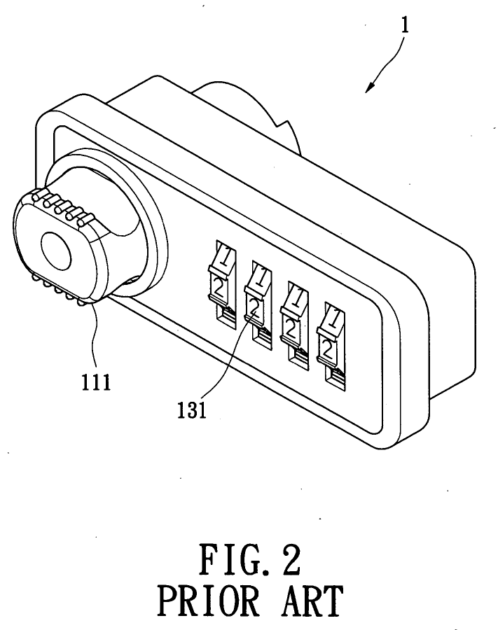

FIG. 3 is an exploded perspective view of a compound locking device of the present invention;

FIG. 4 is a local perspective view of the compound locking device of the present invention;

FIG. 5 is a local perspective view of the compound locking device of the present invention, in which a second shell body and a positioning unit are not yet assembled;

FIG. 6 is a perspective view of the compound locking device of the present invention;

FIG. 7 is a local cross-sectional view of the compound locking device of the present invention in action;

FIG. 8 is a local cross-sectional view of the compound locking device of the present invention restored to the original position; and

FIG. 9 is a perspective view of a compound locking device according to another embodiment of the present invention.

### DETAILED DESCRIPTION OF THE PREFERRED EMBODIMENTS

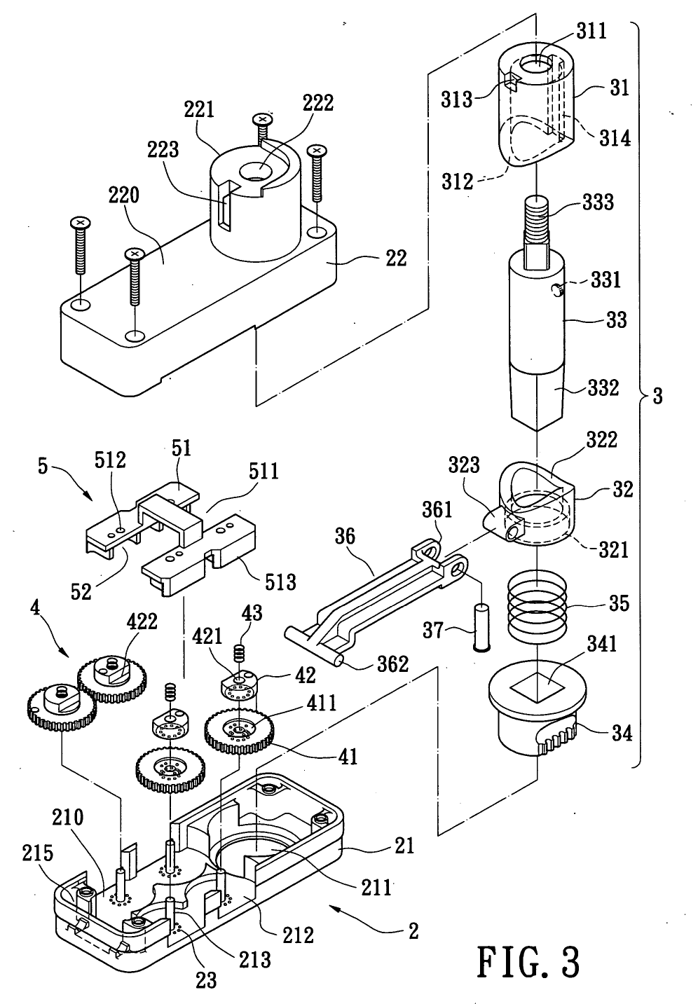

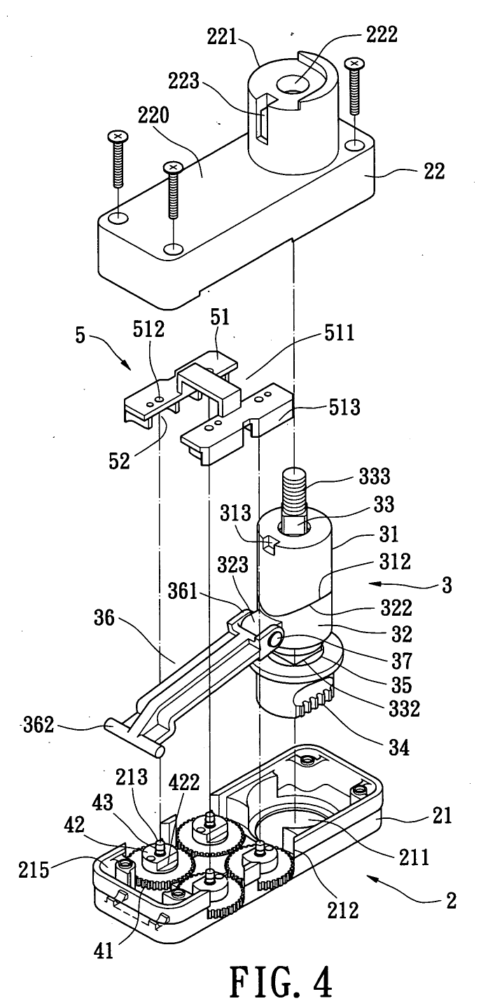

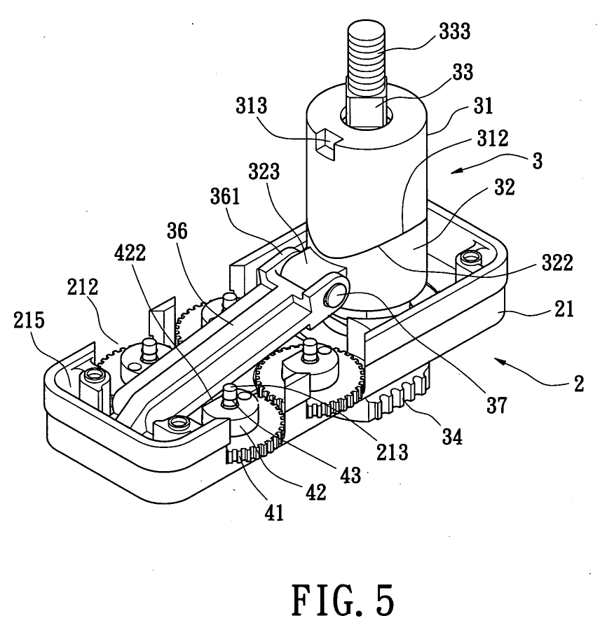

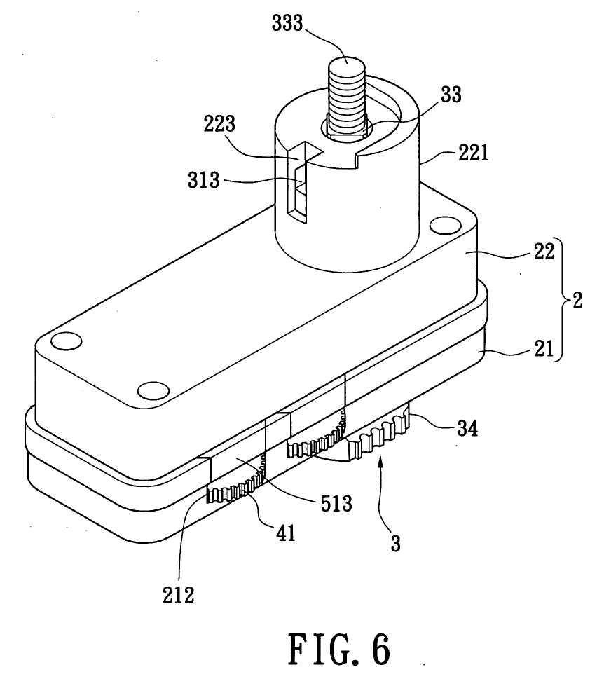

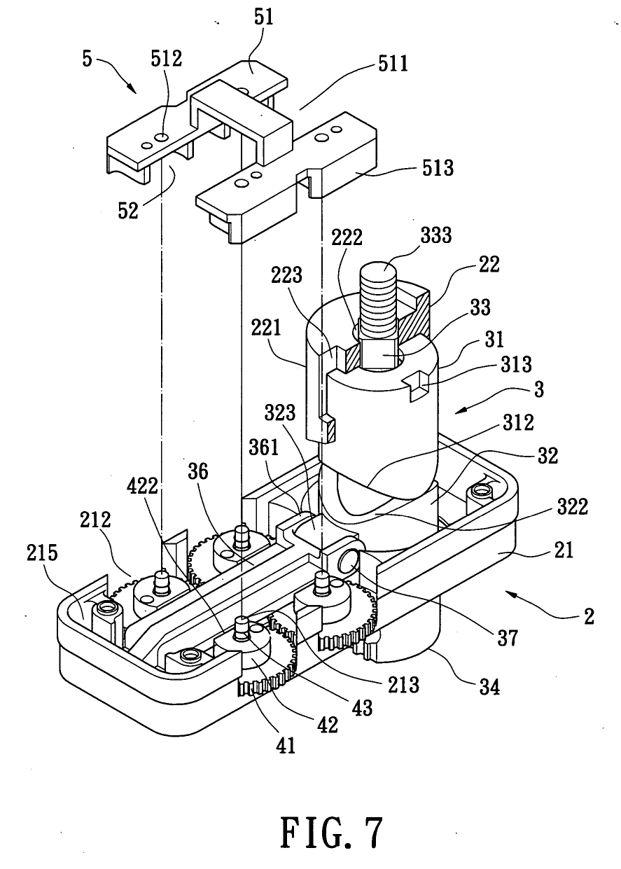

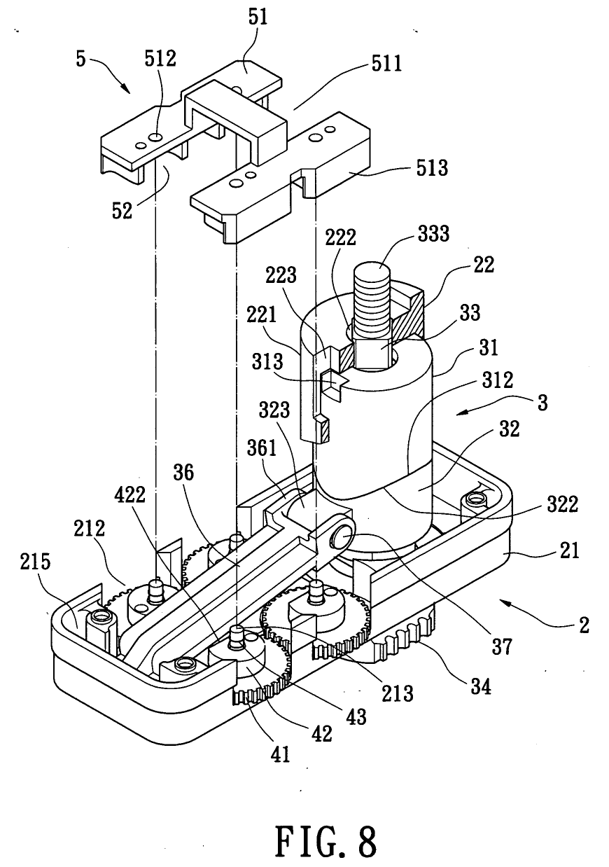

As shown in FIGS. 3 to 8, the present invention provides a compound locking device making use of a key locking mechanism and a combination locking mechanism for joint arrestment. The compound locking device comprises a casing 2, a key locking mechanism 3, a combination locking mechanism 4, and a positioning unit 5. In another embodiment, an auxiliary lock 6 is further provided.

The casing 2 has a first shell body 21 and a second shell body 22 correspondingly jointed together. The key locking mechanism 3, the combination locking mechanism 4, and the positioning unit 5 are disposed in the casing 2. The first shell body 21 has a through opening 211 and a plurality of gaps 212 disposed at the periphery thereof. A limiting groove 215, a plurality of shafts 213 protruding inwards, and a plurality of positioning points 23 surrounding the shafts 213 are formed on an inner wall 210 of the first shell body 21. Each shaft 213 corresponds to one of the gaps 212. The shafts 213 are located between the opening 211 and the limiting groove 215. The positioning points 23 can be positioning bumps, or positioning pits corresponding to the positioning bumps. The corresponding positioning bump and positioning pit are against each other to produce a positioning effect.

The second shell body 22 has an outer wall 220 and a cylinder 221. The cylinder 221 corresponds to the opening 211, and protrudes from the outer wall 220. The cylinder 221 has a through hole 222 connecting inside and outside.

The combination locking mechanism 4 has a plurality of figure wheels 41, a plurality of positioning cam sleeves 42, and a plurality of flexible devices 43. The back side of each figure wheel 41 has a recessed groove 411. Each positioning cam sleeve 42 has an axial accommodating hole 421 and a limiting portion 422. Each shaft 213 first penetrates one figure wheel 41 and then one positioning cam sleeve 41. A flexible device 43 is accommodated in the accommodating hole 421 of each positioning cam sleeve 42. Part of the flexible device 43 is exposed out of the accommodating hole 421. The positioning points 23 are disposed at adjacent sides, between the positioning cam sleeves 42, the figure wheels 41, and the inner wall 210, to form the figure wheels 41, and also to achieve the effect of freely changing the code. If all the limiting portions 22 of two opposite rows of positioning cam sleeves 42 face each other to form jointly a large limiting groove, a tongue plate 36 will sink therein. The edges of the figure wheel 41 are exposed out of the gaps 212 at the periphery of the first shell body 21 so that the user can dial the figure wheels 41. Moreover, the dialed positions are not on the same side.

The key locking mechanism 3 has a first bushing 31, a second bushing 32, a lock body 33, a holding body 34, and a flexible device 35.

The lock body 33 has a conventional lock core (not shown). In addition to a raised key 331, the lock body 33 has also a fixedly-connected portion 332 and a rod portion 333 at two ends thereof.

An annular groove 321 is formed at an inner edge at one end of the hollow second bushing 32, a wedge-shaped edge 322 is formed at the other end thereof, and a pivotally-connected body 323 is disposed at the outer wall thereof. The second bushing 32 is sleeved onto the lock body 33 between the raised key 331 and the fixedly-connected portion 332. The holding body 34 has a fixedly-connected groove 341 corresponding to the fixedly-connected portion 332. The fixedly-connected portion 332 of the lock body 33 is inserted into the fixedly-connected groove 341 of the holding body 34 to be fixed. The flexible device 35 is sleeved onto the lock body 33, and is located between the groove 321 of the second bushing 32 and the holding body 34.

A through hole 311 with a diminishing diameter is formed at one end of the hollow first bushing 31, a wedge-shaped edge 312 corresponding to the above wedge-shaped edge 322 is formed at the other end thereof, and an axial groove 314 is formed at the inner wall thereof. The first bushing 31 is sleeved onto another position of the lock body 33. The raised key 331 of the lock body 33 is accommodated in the groove 314. The rod portion 333 of the lock body 33 protrudes from the through hol2 311. The wedge-shaped edges 312 and 322 of the first bushing 31 and the second bushing 32 correspond to each other and are wedged together so that the first bushing 31 and the second bushing 32 can together form a hollow cylinder. When the first bushing 31 is led to rotate, the wedge-shaped edge 312 will drive the wedge-shaped edge 322 away to let the second bushing 32 to which the wedge-shaped edge 322 belongs move relatively.

A pivotally-connected portion 361 and an end portion 362 are formed at two ends of the tongue plate 36. The pivotally-connected portion 361 of the tongue plate 36 is pivotally connected to the pivotally-connected body 323 of the second bushing 32 and is pivotally fixed by a pivotally-connected component 37.

The key locking mechanism 3 is disposed in the casing 2. The holding body 34 at one end thereof corresponds to the opening 211 of the first shell body 21 to be accommodated and positioned. The first bushing 31 at the other end thereof is accommodated in the cylinder portion 221 of the second shell body 22. The holding body 34 and the rod portion 333 penetrate out of the opening 211 and the through hole 222 of the first and second shell bodies 21 and 22, respectively. The holding body 33 is held and rotated by a human hand, while the rod portion 333 is used for installation of other components (not shown) of the key locking mechanism 3. The end portion 362 of the tongue plate 36 is accommodated in the limiting groove 215 of the first shell body 21 to be positioned.

The positioning unit 5 can be a separate unit or integrally formed in the second shell body 22. In this embodiment, the positioning unit 5 is a separate unit.

The positioning unit 5 has a positioning body 51 and a plurality of chambers 52 formed at one side of the positioning body 51. The positioning body 51 has a passageway 511 for motion of the tongue plate 36 and a plurality of through holes 512 corresponding to the shafts 213. The chambers 52 correspond to the positioning cam sleeves 42 for accommodating them. The chambers 52 are open, and the limiting portions 422 of the positioning cam sleeve 42 can be exposed out of the chambers. The positioning unit 5 covers the inside of the first shell body 21 to embed each side 513 of the positioning body 51 into one of the gaps 212 of the first shell body 21. Each through hole 512 is sleeved onto the corresponding shaft 213. Each chamber 52 receives the corresponding positioning cam sleeve 42. The flexible devices 43 are elastically supported between the positioning body 51 and the positioning cam sleeves 42. The tongue plate 36 moves in the passageway 511.

In this embodiment, the lock body 33 of the key locking mechanism 3 has a conventional lock core. A key hole (not shown) is disposed at a free end of the fixedly-connected portion 332 thereof. A user can use a key to unlock the key locking mechanism 3.

After the key locking mechanism 3 is unlocked, it is also necessary to rotate the holding body 34 to release the locking state of the compound locking device. When the holding body 34 is rotated, the lock body 33 will lead the first bushing 31 to rotate synchronously so as to drive the second bushing 32 to move toward the inner wall 210 of the first shell body 21, hence leading the tongue plate 36 pivotally connected thereon to move in the same direction. Meanwhile, if any one of the figure wheels 41 in the combination locking mechanism 4 is not dialed to the correct number, the limiting portions 422 of the two-row positioning cam sleeves 42 do not form a large limiting groove (not shown). The tongue plate 36 moving in the same direction with the second bushing 32 thus cannot sink into the large limiting groove. Therefore, the first bushing 31, the lock body 33, and the holding body 34 cannot be rotated to release the locking state of the compound locking device. This is the principle of the compound locking device. Any one wanting to unlock the compound locking device needs to have both the key and the unlocking code. If one has both the key and the unlocking code, the limiting portions 422 of the two-row positioning cam sleeves 42 will form a large limiting groove, and the tongue plate 36 can sink into the large limiting groove along with the motion of the second bushing 32 so that the first bushing 31 can be rotated. In other words, the holding body 34 can be rotated to release the locking state of the compound locking device.

Furthermore, the preset code of the combination locking mechanism 4 can be changed only if the compound locking device is in the unlocking state. After the tongue plate 36 sinks into the large limiting groove, the limiting portions 422 will be restrained simultaneously so that the positioning cam sleeves 42 cannot be rotated. Only the figure wheels 41 can be rotated to accomplish the object of changing the code.

In another embodiment of the present invention, the first bushing 31 and the second bushing 32 of the key locking mechanism 3 are accommodated in the cylinder portion 221 of the second shell body 22. A stop portion 313 is disposed at a eccentric position on the outer wall of the first bushing 31. The cylinder portion 221 of the second shell body 22 has an action trench 223 corresponding to the stop portion 313. The stop portion 313 can penetrate out of the action trench 223.

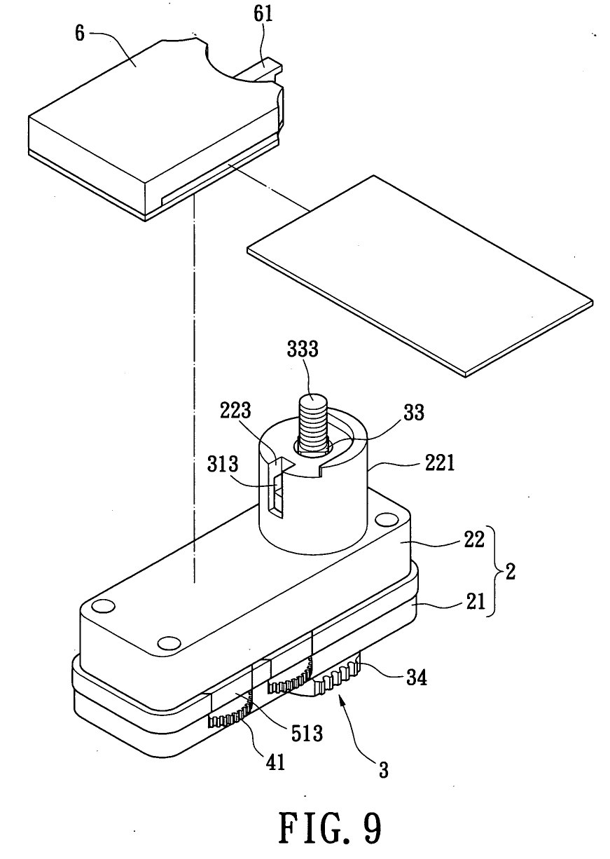

As shown in FIG. 9, a card-insertion type or coin-operated auxiliary lock 6 is further disposed on the second shell body 22. The auxiliary lock 6 has a stop rod 61 capable of moving due to card insertion or coin dropping. The stop rod 61 is inserted into the stop portion 313 of the first bushing 31 to restrain the first bushing 31 from rotating. That is, when one wants to use the compound locking device, he has to first insert the card or a coin to move the stop rod 61 of the auxiliary lock 6 out of the stop portion 313. With a storage cabinet as an example, the auxiliary lock 6 can prevent others (especially children) from carelessly changing the number or closing the cabinet door to result in an inability to distinguish which cabinets have been used and which cabinets have not been used.

To sum up, because not all the figure wheels 41 are located on the same side, the present invention can effectively prevent others from trying out the unlocking number. Moreover, because all the figure wheels 41 are not serially connected together as in the prior art but are arranged side by side instead, the present invention has the advantage of easy assembly. With the addition of special structural designs of other parts, the assembly of the present invention is much easier. Furthermore, when one wants to change the code, it is not necessary for him to detach any object. He can arbitrarily change the code after the unlocking actions of the compound locking device are finished. An auxiliary lock can also be added to effectively prevent others from purposely or carelessly changing the number.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A compound locking device comprising:
a casing;
a combination locking mechanism disposed at a position in said casing, said combination locking mechanism having a plurality of pairs of figure wheels and positioning cam sleeves pivotally connected to said casing and arranged in at least two rows, each said positioning cam sleeve having a limiting portion, all said limiting portions forming a whole large limiting groove if all figures are correct; and
a key locking mechanism pivotally disposed at another position in said casing, said key locking mechanism having a lock body, a first bushing and a second bushing respectively sleeved onto said lock body, and a tongue plate disposed on said second bushing, said first bushing being linked with said lock body to be rotatable, said first and second bushings being connected together by means of wedge grafting, and said first bushing being rotated to leave said second bushing for embedding said tongue plate into said large limiting groove.

2. The compound locking device as claimed in claim 1, wherein a raised key is disposed on an outer wall of said lock body in said key locking mechanism, a corresponding axial groove is disposed on an inner wall of said first bushing, and said raised key is accommodated in said groove.

3. The compound locking device as claimed in claim 1, wherein said key locking mechanism further has a flexible device and a holding body, said holding body is fixedly connected at one end of said lock body, and said flexible device is sleeved onto said lock body between said second bushing and said holding body and is elastically supported between said second bushing and said holding body.

4. The compound locking device as claimed in claim 1, wherein a limiting groove is provided in said casing, a free end of said tongue plate in said key locking mechanism is restricted by said limiting groove, and the other end of said tongue plate is pivotally connected to said second bushing.

5. The compound locking device as claimed in claim 1, further comprising a positioning unit located in said casing, wherein said positioning unit has a plurality of chambers, each said positioning cam sleeve is accommodated in one of said chambers and can rotate freely therein, and said limiting portion of each said positioning cam sleeve is exposed out of said chamber.

6. The compound locking device as claimed in claim 5, wherein a flexible device is further disposed between said positioning unit and each said positioning cam sleeve.

7. The compound locking device as claimed in claim 5, wherein said positioning unit is directly formed on an inner wall of said casing.

8. The compound locking device as claimed in claim 5, wherein said positioning unit comprises a positioning body with a plurality of through holes, a passageway for motion of said tongue plate, and said plurality of chambers, and wherein each said chamber is formed at one side of said positioning unit, each said chamber is open to connect with said passageway, said limiting portion of each said positioning cam sleeve is exposed out one of said chambers, each said through hole of said positioning body corresponds to a shaft, each said pair of figure wheels and positioning cam sleeves is clamped between said positioning unit and the inner wall of said casing, and each said shaft penetrates through one of said through holes.

9. The compound locking device as claimed in claim 5, wherein said casing has a first shell body and a second shell body correspondingly joined together, a plurality of gaps is disposed at a periphery of said first shell body, said positioning unit has a plurality of sides corresponding to said gaps, said positioning unit covers an inside of said first shell body, and each said side of said positioning unit is embedded into one of said gaps of said first shell body for positioning.

10. The compound locking device as claimed in claim 1, wherein said casing has a first shell body and a second shell body correspondingly joined together, a plurality of shafts is disposed on an inner wall of said first shell body, each said pair of figure wheels and said positioning cam sleeves is pivotally connected to one of said shafts, and an edge of each said figure wheel is exposed out of said casing.

11. The compound locking device as claimed in claim 10, wherein a plurality of positioning points is disposed at adjacent sides, between said positioning cam sleeves, said figure wheels of said combination locking mechanism, and the inner wall of said first shell body.

12. The compound locking device as claimed in claim 10, wherein said seconds shell body has further an auxiliary lock and a cylinder connected with an inside of said casing, said cylinder has an action trench, said key locking mechanism is accommodated in said cylinder, said first bushing of said key locking mechanism has a stop portion corresponding to said action trench, said auxiliary lock has a stop rod capable of moving after said auxiliary lock is unlocked, and said stop rod is stopped by the stop portion by said action trench.
